(19) United States
(12) Patent Application Publication
(10) Pub. No.: US 2004/0114089 A1
(43) Pub. Date: Jun. 17, 2004

(54) Manufacturing method for liquid crystal display device

(75) Inventor: Myung-Ho Do, Gyeongsangbuk-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/404,348

(22) Filed: Apr. 2, 2003

(30) Foreign Application Priority Data
Dec. 16, 2002 (KR) 2002-80420

(51) Int. Cl. G02F 1/1333

(52) U.S. Cl. 349/158; 349/110

(57) ABSTRACT

A method for manufacturing a liquid crystal display device includes preparing first and second substrates having a plurality of cells, the first substrate having a black matrix and a color filter and the second substrate having a thin film transistor, forming first and second alignment layers on the first and second substrates, forming a seal pattern on one of the first and second substrates, attaching the first and second substrates, and cutting the attached first and second substrates into a plurality of individual liquid crystal cells along a scribing line at an area outside of the black matrix.

The present invention claims benefit of Korean Patent Applications No. 2002-80420, filed in Korea on Dec. 16, 2002, which is hereby incorporated by reference.

### BACKGROUND OF THE INVENTION

1. Field of the Invention

The present invention relates to a liquid crystal display (LCD) device and more particularly, to a manufacturing method for a liquid crystal cell featuring a cell scribing method.

2. Discussion of the Related Art

Among the different many types of flat panel display devices currently being developed, liquid crystal display (LCD) devices are one of the most commonly used for notebook and desktop computers because of their superior high resolution, color display, and image display quality. In general, the liquid crystal display (LCD) device includes a lower substrate having a thin film transistor and an upper substrate having a color filter, and a liquid crystal layer injected between the upper and lower substrates. The liquid crystal display (LCD) device further includes electrodes on the upper and lower substrates for providing an electric field between the upper and lower substrates. Once a voltage is supplied to electrodes of the upper and lower substrates, an electric field is generated between electrodes of the upper and lower substrates. The electric field aligns liquid crystal molecules of the liquid crystal layer, thereby displaying an image by changing light transmittance.

FIG. 1 a plan view of a liquid crystal display panel having a black matrix according to the related art. In FIG. 1, a liquid crystal display panel 50 includes an upper substrate 20 having a black matrix 40 and a color filter (not shown) formed thereon, a lower substrate 10 having a thin film transistor (not shown) formed thereon and attached to the upper substrate 20, and a liquid crystal layer (not shown) injected between the upper and lower substrates 20 and 10. In addition, a seal pattern 35 is formed on one of the upper and lower substrates 20 and 10 to maintain a uniform cell gap between the upper and lower substrates 20 and 10 and to prevent the injected liquid crystal layer from leaking out. The liquid crystal display panel 50 includes an active area “A” for displaying images and non-active areas “NA1” and “NA2.”

FIG. 2 is a cross-sectional view of a liquid crystal display panel having a black matrix according to the related art. In FIG. 2, a black matrix 40 is formed on an interior surface of an upper substrate 20, and a color filter layer 22 is formed beneath the black matrix 40. A common electrode 24 used for forming an electric field between the upper substrate 20 and a lower substrate 10 is formed of a conductive metal material beneath the color filter layer 22. A plurality of pixels and a plurality of thin film transistors corresponding to the plurality of pixels are defined within the active area “A” of the lower substrate 10. Each of the thin film transistors includes a gate electrode 11, an active layer 12, an ohmic contact layer 14, a source electrode 16a, and a drain electrode 16b. A pixel electrode 18 forming the electric field between the upper and lower substrates 20 and 10 is formed on the lower substrate 10 and is connected to the drain electrode 16b. The upper and lower substrates 20 and 10 are attached by the seal pattern 35 formed on one of the upper and lower substrates 20 and 10 within the non-active area “NA1” and “NA2” (in FIG. 1). Then, liquid crystal material 30 is injected into a space formed between the upper and lower substrates 20 and 10 and bounded by the seal pattern 35.

The black matrix 40 is commonly formed within the active area “A” that corresponds to the thin film transistors, and within the non-active areas “NA1” to cover links formed within the non-active area “NA1” that interconnects gate and data lines to gate and data pads, respectively. The black matrix 40 is commonly formed along a boundary of each sub-color filters red (R), green (G), and blue (B) to prevent light from leaking out near the thin film transistor “T.” In addition, the black matrix 40 is formed along boundaries of the active area “A” to prevent the light from leaking out in the non-active area “NA1”. The black matrix 40 is commonly formed of organic materials, such as carbon(C) and chromium (Cr) thin films having an optical density of above 3.5. A black matrix having a dual layered structure of Cr/CrOₓ may be used for reducing a reflection ratio of a liquid crystal display device. Recently, a black matrix resin has been used for the black matrix material instead of chromium (Cr) black matrix material because the forming processes are simplified. Thus, production costs are lowered. For example, an in-plane switching mode (IPS) liquid crystal display (LCD) device uses the black matrix resin. However, the black matrix resin has poor adhesion properties with the seal pattern 35 as compared to the black matrix having a metal material, such as chromium (Cr). A fabrication sequence of the liquid crystal display panel 50 having the black matrix that includes the metal material will be described hereinafter.

The common electrode 24 and the pixel electrode 18 are formed on the upper and lower substrates 20 and 10, respectively. Next, liquid crystal material is injected into a space between the upper and lower substrates 20 and 10, and an injection hole is sealed with sealing material. A liquid crystal cell is completed by forming polarizers on exterior surfaces of the upper and lower substrates 20 and 10. A total process for forming a liquid crystal cell can be classified into an alignment layer forming process, a cell gap forming process, a liquid crystal injection process, and a cell cutting process. The cell cutting process includes cutting the liquid crystal display panel into individual liquid crystal cells after a hardening process of the seal pattern. Previously, the cell cutting process has been performed after injecting liquid crystal material into the liquid crystal display panel having a plurality of liquid crystal cells. However, as a size of the liquid crystal cell increases, the liquid crystal display panel is cut into individual liquid crystal cells and then the liquid crystal material is injected into the individual liquid crystal cells. The cell cutting process can be divided into a scribing process in which a scribing line is formed on a surface of a glass substrate by a diamond pen having a higher hardness than glass, and a breaking process in which the glass substrate is separated along the scribing line by slightly impacting the glass substrate.

FIG. 3 is a cross-sectional view of a liquid crystal display panel having a cell cutting position according to the related art. In FIG. 3, laminated structures formed on the upper and lower substrates 20 and 10 are omitted for the sake of explanation. The upper substrate 20 and the lower substrate 10 opposing the upper substrate 20 are spaced apart from each other, and the black matrix 40 is formed on an interior surface of the upper substrate 20 and the color filter 22 is formed beneath the black matrix 40. The cell cutting process has been performed within a portion of the black matrix 40 formed within the non-active area “NA1” (in FIG. 2). For example, a cell cutting line 42 passes through the black matrix 40, whereby portions of the upper and lower substrates 20 and 10 and the portion of the black matrix 40 on the left side are cut away. Accordingly, as shown in a dotted circle in FIG. 2, an end of the cut black matrix 40 coincides with an end of the cut upper substrate 20 after the upper substrate 20 and the black matrix 40 are cut. However, if the black matrix 40 includes the metal material, such as chromium (Cr), the cut section of the black matrix 40 is exposed to air. Accordingly, the metal component included in the exposed black matrix section may react with oxygen or moisture in the air, thereby forming rust. Accordingly, the rusted black matrix 40 may cause an operational defect in the liquid crystal display (LCD) device.

### SUMMARY OF THE INVENTION

Accordingly, the present invention is directed to an array substrate for a liquid crystal display (LCD) device that substantially obviates one or more of the problems due to limitations and disadvantages of the related art.

An object of the present invention is to provide a method for manufacturing a liquid crystal cell of a liquid crystal display (LCD) device by disposing a scribing line at an outer area of a black matrix.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for manufacturing a liquid crystal display device includes preparing first and second substrates having a plurality of cells, the first substrate having a black matrix and a color filter and the second substrate having a thin film transistor, forming first and second alignment layers on the first and second substrates, forming a seal pattern on one of the first and second substrates, attaching the first and second substrates, and cutting the attached first and second substrates into a plurality of individual liquid crystal cells along a scribing line at an area outside of the black matrix.

In another aspect, a method for manufacturing a liquid crystal display panel includes forming a black matrix on a first region of an interior surface of a first substrate, forming a seal pattern on along a perimeter region of an interior surface of a second substrate, attaching the first and second substrates, injecting liquid crystal material into a gap between the attached first and second substrates, forming a scribing line on an exterior surface of the first substrate by a first distance from the first region, separating the attached first and second substrates into a liquid crystal cell along the scribing line, and grinding edge portions of the liquid crystal cell.

In another aspect, a method for manufacturing a liquid crystal display panel includes forming a black matrix on a first region of an interior surface of a first substrate, forming a seal pattern on along a perimeter region of an interior surface of a second substrate, forming liquid crystal material within the perimeter region of the second substrate, attaching the first and second substrates, forming a scribing line on an exterior surface of the first substrate by a first distance from the first region, and separating the attached first and second substrates into a liquid crystal cell along the scribing line.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a plan view of a liquid crystal display panel having a black matrix according to the related art;

FIG. 2 is a cross-sectional view of a liquid crystal display panel having a black matrix according to the related art;

FIG. 3 is a cross-sectional view of a liquid crystal display panel having a cell cutting position according to the related art;

FIG. 4 is a flow chart of an exemplary fabrication process for a liquid crystal cell according to the present invention;

FIG. 5 is a cross-sectional view of an exemplary liquid crystal display panel having a cell cutting position according to the present invention;

FIG. 6A is a cross-sectional view of another exemplary liquid crystal display panel during a cell scribing process according to the present invention;

FIG. 6B is a cross-sectional view of another exemplary liquid crystal display panel during a cell dividing process according to the present invention;

FIG. 7 is a plan view of another exemplary liquid crystal display panel according to the present invention; and

FIG. 8 is a cross-sectional view of another exemplary liquid crystal display panel according to the present invention.

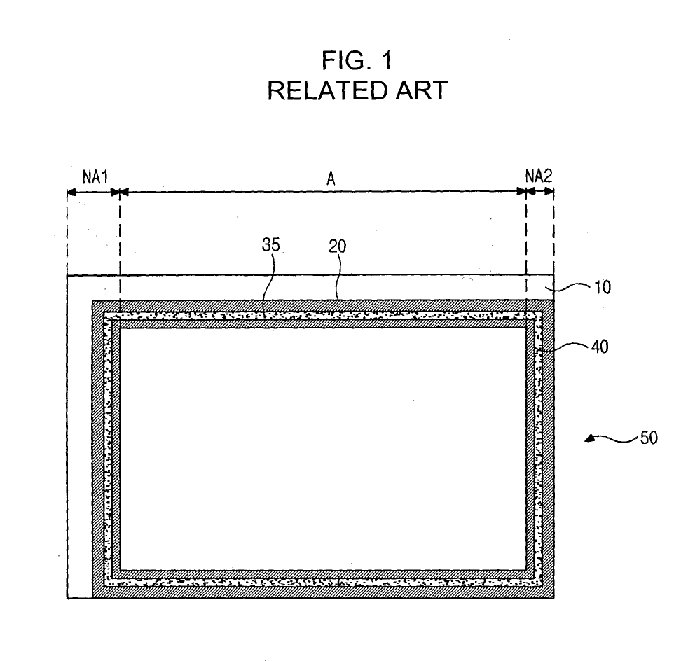

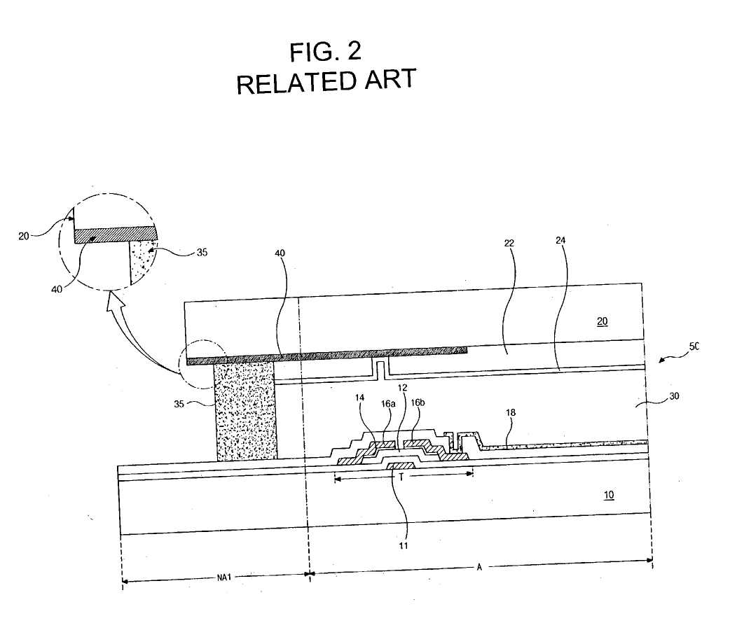

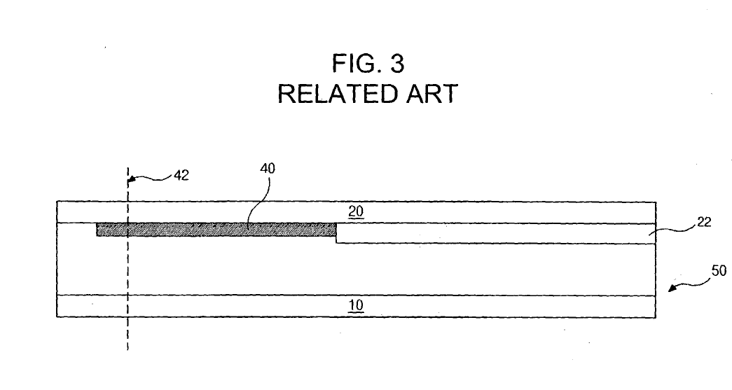

### DETAILED DESCRIPTION OF THE EMBODIMENTS

Reference will now be made in detail to the illustrated embodiment of the present invention, which is illustrated in the accompanying drawings.

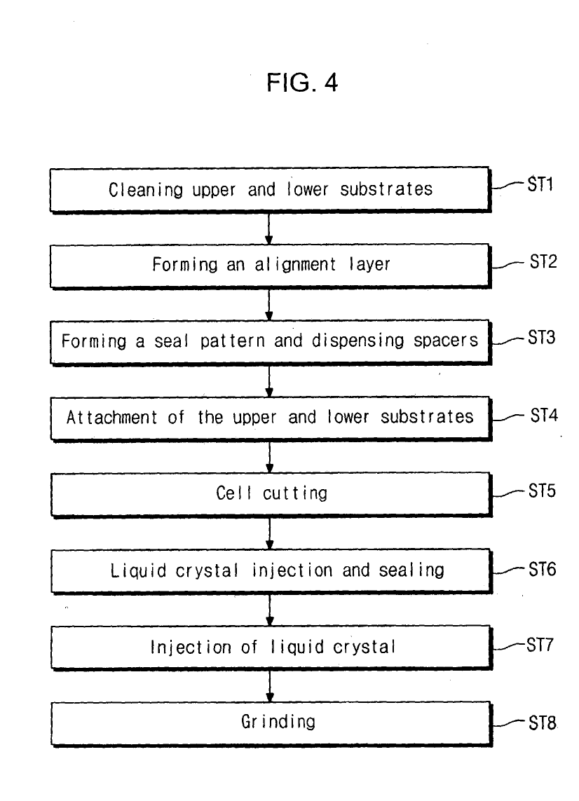

FIG. 4 is a flow chart of an exemplary fabrication process for a liquid crystal cell according to the present invention. In FIG. 4, a first step STI may include forming laminated structures on upper and lower substrates, and then cleaning the upper and lower substrates to remove contaminants. At this time, the upper and lower substrates may include a plurality of liquid crystal cells formed thereon.

In second step ST2, alignment layers may be formed on the upper and lower substrates by depositing polymer thin films on the upper and lower substrates, and then rubbing the deposited polymer thin films. The alignment layer forming process creates a uniform alignment of liquid crystal molecules, whereby the liquid crystal molecules may have a uniform display property. It may be necessary that the alignment layers be uniformly coated on a large area of the upper and lower substrates. The alignment layers may be formed of polyimide-based polymers, wherein the coated alignment layers may be transformed into a polyimide film by processing in a preliminary drier and a hardening oven. The rubbing process may be performed on the alignment layers by rubbing a surface of the alignment layers along a certain direction by a rubbing fabric, for example, whereby the liquid crystal molecules become aligned according to the rubbing direction.

In a third step ST3, a seal pattern may be formed on one of the upper and lower substrates, and spacers may be dispensed on the substrate. The seal pattern may function to maintain an uniform cell gap between the upper and lower substrates, and may prevent leakage of the liquid crystal material injected into a space between the upper and lower substrates. The seal pattern may be formed of thermo-hardening resin, which may include glass fiber or may be formed of photo-hardening resins, by a screen-printing method or a dispensing method. The spacers may be dispensed on the substrate with a uniform distribution density, and may be formed on the substrate using a wet dispensing method or a dry dispensing method. For example, a mixture of the spacers and alcohol may be sprayed onto the substrate during the wet dispensing method, whereas only spacers are dispensed on the substrate during the dry dispensing method. Alternatively, a combination of the wet and dry dispensing methods may be used.

In a fourth step ST4, the upper and lower substrates may be attached together. An alignment degree of the upper and lower substrates may be determined by pre-designed error margin, and may require an accuracy of a few micrometers (μm). If the alignment degree of the upper and lower substrates deviates from the pre-designed error margin, light may leak from the device resulting in poor operational characteristics of the liquid crystal display (LCD) device.

In a fifth step ST5, the attached upper and lower substrates may be cut into a plurality of individual liquid crystal cells. For example, a plurality of individual liquid crystal cells may be formed on a large glass substrate, and then cut into the plurality of individual liquid crystal cells during a cell cutting process. The cell cutting process may include a scribing process and a breaking process. During the scribing process, a scribing line may be formed on the glass substrate by a diamond pen or a tungsten-carbide wheel having a hardness larger than glass. During the breaking process, the glass substrate may be cut along the scribing line by slightly impacting the glass substrate.

In a sixth step ST6, liquid crystal material may be injected into each of the individual liquid crystal cells through an injection hole. The individual liquid crystal cells may have a cell gap of a few micrometers (μm) per a few square centimeters (cm²). Accordingly, a vacuum injection method may be used to effectively inject the liquid crystal material into the liquid crystal cell. After injection of the liquid crystal material is complete, the injection hole may be sealed to prevent the injected liquid crystal material from leaking out of the injection hole. The injection hole may be sealed by forming photo-hardening resin on the injection hole by a dispenser, and then irradiating the photo-hardening resin with ultraviolet light. Accordingly, if the injection hole contacts exterior materials while the liquid crystal material is injected, the injected liquid crystal material may become contaminated. Thus, it is important the injection hole not contact the exterior material during moving the liquid crystal cell and during subsequent processing. In addition, the liquid crystal cell must not be left exposed to exterior conditions for a long period of time.

Alternatively, the liquid crystal material may be dropped onto one of the upper and lower substrates, then the upper and lower substrates may be attached and the cell cutting process may be performed. At this time, the seal pattern may not have an injection hole, thereby photo-hardening resin or photo-and-thermo-hardening resin may be used for the seal pattern.

In a seventh step ST7, the liquid crystal cell may be inspected. During the inspection process, a plurality of gate lines and a plurality of data lines may be connected to an inspection pad formed within a marginal space of the lower substrate via a shorting bar, and a common electrode on the upper substrate may be connected to another inspection pad. Accordingly, the liquid crystal cell may be visually inspected by a macroscopic observation, i.e. naked eye, or by a microscopic observation while applying voltage to the liquid crystal cell via the inspection pads. During the inspection process, many different types of defects, such as contaminants, defective thin film transistor elements, breakage of gate and data lines, and irregular thickness of the liquid crystal cell, may be inspected.

In an eighth step ST8, a grinding process may be performed on the liquid crystal cell after the inspection process has been completed. The grinding process may include conditioning of edge portions of the cut glass substrate to remove any defects or sharp edges. In addition, any static electricity accumulated during the fabrication process may be discharged, and the shorting bar may be cut away from the liquid crystal cell. After the grinding process, the liquid crystal cell may go through a liquid crystal module process in which upper and lower frames are attached to the liquid crystal cell.

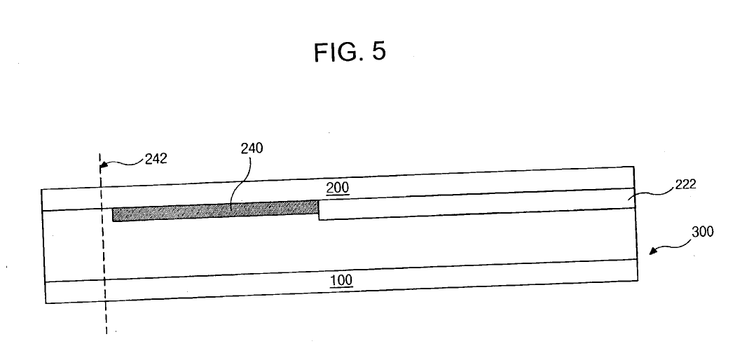

FIG. 5 is a cross-sectional view of an exemplary liquid crystal display panel having a cell cutting position according to the present invention. In FIG. 5, an upper substrate 200 and a lower substrate 100 opposing the upper substrate 200 may be spaced apart from each other. In addition, a black matrix 240 may be formed on an interior surface of the upper substrate 200, and a color filter 222 may be sequentially formed beneath the black matrix 240. Other laminated structures on the upper and lower substrates 200 and 100 have been omitted for the sake of explanation, but are nonetheless included. A scribing line 242 may be disposed at a position outside of the black matrix 240 so that the black matrix 240 is not severed during a step of cell cutting.

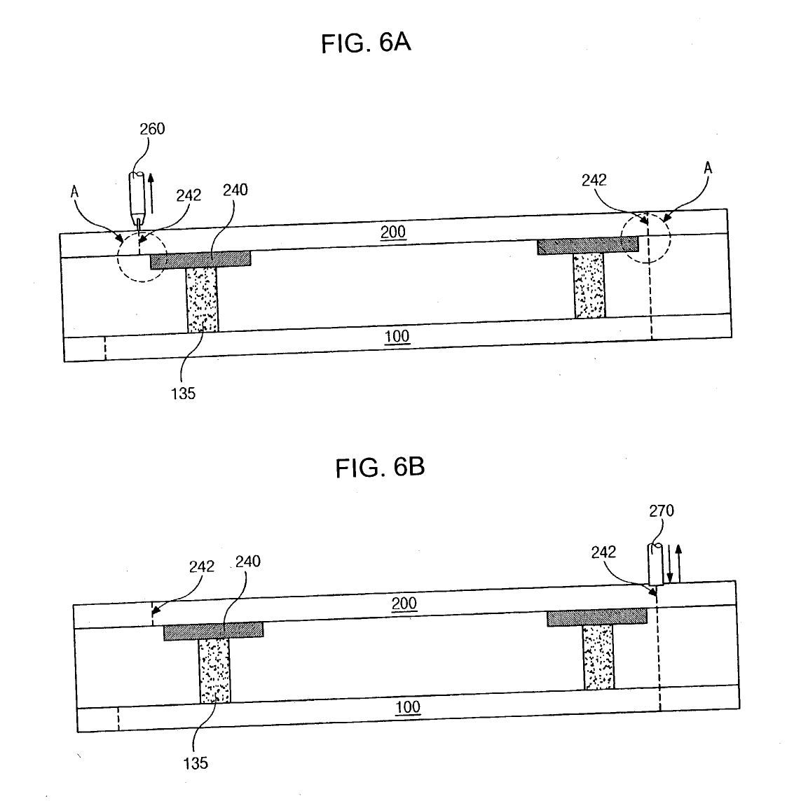

FIG. 6A is a cross-sectional view of another exemplary liquid crystal display panel during a cell scribing process according to the present invention. In FIG. 6A, upper and lower substrates 200 and 100 may be attached together by a seal pattern 135 between the upper and lower substrates 200 and 100. The black matrix 240 may be formed on the upper substrate 200 along a boundary between active and non-active areas (not shown). The black matrix formed within the active area (not shown) and other laminated structures between the upper and lower substrates 200 and 100 have been omitted for the sake of explanation. A tungsten-carbide alloyed wheel 260 may be moved along the upper substrate 200 to make a scribing line 242 on the upper substrate 200 at an outside area of the black matrix 240. Here, a dotted circle “A” in FIG. 6A corresponds to the dotted line in FIG. 5. Thus, the dotted linear line in FIG. 6A is the scribing line 242 and the scribing line 242 is disposed at the outside area of the black matrix 240 to prevent the black matrix 240 from being cut.

FIG. 6B is a cross-sectional view of another exemplary liquid crystal display panel during a cell dividing process according to the present invention. In FIG. 6B, the liquid crystal cell may be separated from the upper and lower substrates 200 and 100 by a momentary impact of a breaking bar 270.

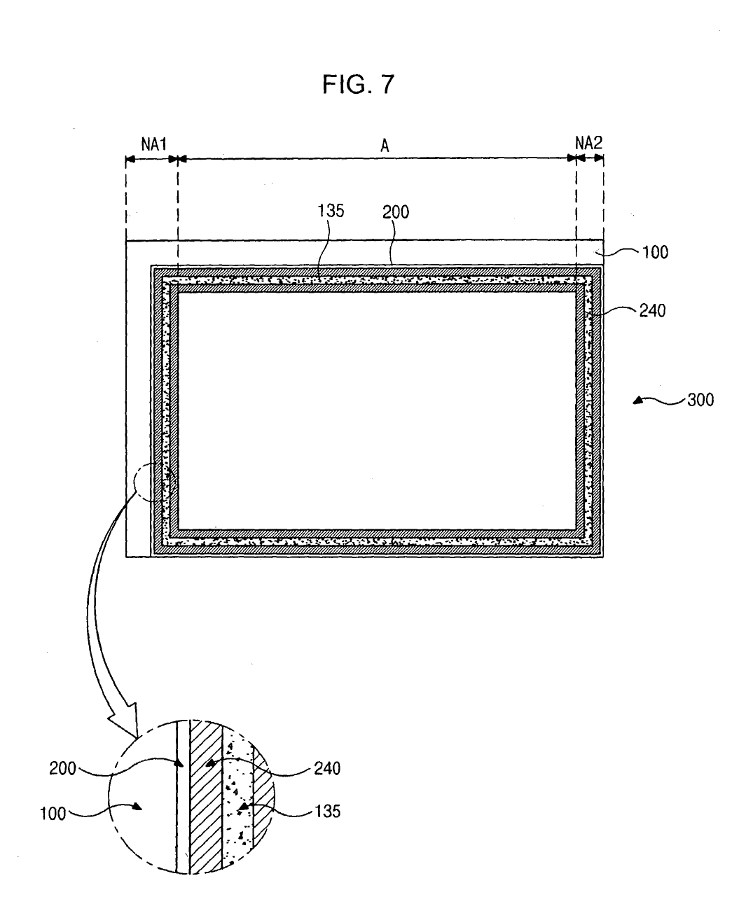

FIG. 7 is a plan view of another exemplary liquid crystal display panel according to the present invention. In FIG. 7, a liquid crystal display panel 300 may include an upper substrate 200 having a color filter (not shown), and a lower substrate 100 having a plurality of thin film transistors (not shown) opposed and spaced apart from the upper substrate 200. The upper and lower substrates 200 and 100 may be attached together by a seal pattern 135 formed on one of the upper and lower substrates 200 and 100, and a liquid crystal material (not shown) may be disposed between the upper and lower substrates 200 and 100. In addition, the liquid crystal display panel 300 may include a black matrix 240 formed along edges of an active area “A.” As shown in a dotted circle in FIG. 7, an end of the black matrix 240 may not coincide with an end of the upper substrate 200. Accordingly, during a cell cutting process, the attached substrates may be divided into individual liquid crystal cells by cutting at an area outside of the black matrix 240 without cutting the black matrix 240.

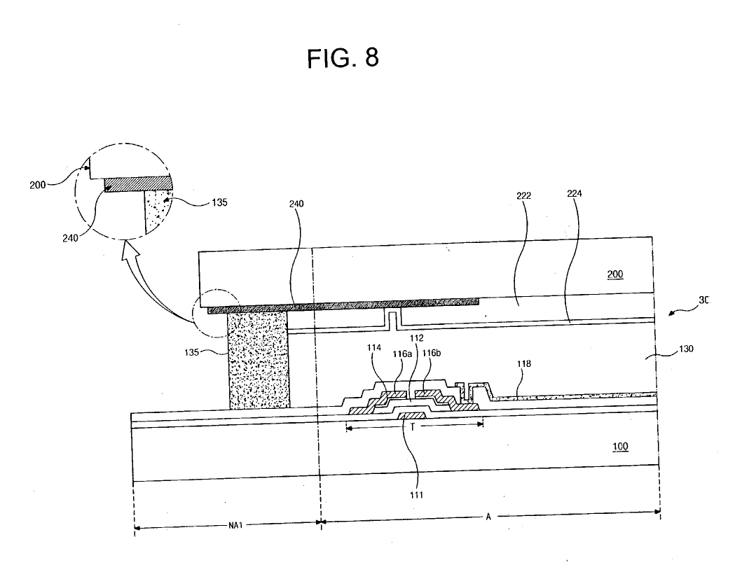

FIG. 8 is a cross-sectional view of another exemplary liquid crystal display panel according to the present invention. In FIG. 8, a black matrix 240 may be formed on an interior surface of an upper substrate 200, and a color filter layer 222 may be formed beneath the black matrix 240. In addition, a common electrode 224 may be formed beneath the color filter layer 222. A thin film transistor “T” having a gate electrode 111, an active layer 112, an ohmic contact layer 114, a source electrode 116a, and a drain electrode 116b may be formed on the lower substrate 100 in a region corresponding to the black matrix 240. In addition, a pixel electrode 118 may be connected to the drain electrode 116b. The upper and lower substrates 200 and 100 may be attached to each other by a seal pattern 135 formed on one of the upper and lower substrates 200 and 100. The common and pixel electrodes 224 and 118 may be formed on a same substrate, for example the lower substrate 100. A dotted circle in FIG. 8 is an expanded drawing of end portions of the upper substrate 200 and the black matrix 240 after the cell cutting process according to the present invention. As shown in the dotted circle, there is an interval between the end of the upper substrate 200 and the end of the black matrix 240 owing to the cell cutting method according to the present invention.

It will be apparent to those skilled in the art that various modifications and variation can be made in the fabrication and application of the present invention without departing from the spirit or scope of the invention. Thus, it is intended that the present invention cover the modifications and variations of this invention provided they come within the scope of the appended claims and their equivalents.

What is claimed is:

1. A method for manufacturing a liquid crystal display device, comprising:
preparing first and second substrates having a plurality of cells, the first substrate having a black matrix and a color filter and the second substrate having a thin film transistor;
forming first and second alignment layers on the first and second substrates;
forming a seal pattern on one of the first and second substrates;
attaching the first and second substrates; and
cutting the attached first and second substrates into a plurality of individual liquid crystal cells along a scribing line at an area outside of the black matrix.

2. The method according to claim 1, wherein the black matrix includes a metal film.

3. The method according to claim 1, further comprising:
forming a common electrode on the first substrate; and
forming a pixel electrode on the second substrate.

4. The method according to claim 1, further comprising:
forming a common electrode on the second substrate; and
forming a pixel electrode on the second substrate.

5. The method according to claim 1, further comprising forming spacers on the second substrate.

6. The method according to claim 1, further comprising cleaning the first and second substrates before forming the first and second alignment layers.

7. A method for manufacturing a liquid crystal display panel, comprising:
forming a black matrix on a first region of an interior surface of a first substrate;
forming a seal pattern on along a perimeter region of an interior surface of a second substrate;
attaching the first and second substrates;
injecting liquid crystal material into a gap between the attached first and second substrates;
forming a scribing line on an exterior surface of the first substrate by a first distance from the first region;
separating the attached first and second substrates into a liquid crystal cell along the scribing line; and
grinding edge portions of the liquid crystal cell.

8. The method according to claim 7, further comprising inspecting the liquid crystal cell after grinding edge portions of the liquid crystal cell.

9. The method according to claim 7, wherein one of the first and second substrates includes a plurality of gate lines and a plurality of data lines.

10. The method according to claim 9, further comprising inspecting the liquid crystal cell after grinding edge portions of the liquid crystal cell.

11. The method according to claim 10, wherein the inspecting the liquid crystal cell includes supplying the gate and data lines with voltages via shorting bars.

12. The method according to claim 11, wherein the grinding edge portions of the liquid crystal cell includes removing the shorting bars.

13. The method according to claim 12, further comprising attaching upper and lower frames to the liquid crystal cell.

14. The method according to claim 7, wherein the attached substrates include an active region and a non-active region surrounding the active region.

15. The method according to claim 14, wherein the first region is disposed between the active and non-active regions.

16. The method according to claim 7, wherein the separating the attached first and second substrates includes impacting the second substrate along the scribing line.

17. A method for manufacturing a liquid crystal display panel, comprising:
forming a black matrix on a first region of an interior surface of a first substrate;
forming a seal pattern on along a perimeter region of an interior surface of a second substrate;
forming liquid crystal material within the perimeter region of the second substrate;
attaching the first and second substrates;
forming a scribing line on an exterior surface of the first substrate by a first distance from the first region; and
separating the attached first and second substrates into a liquid crystal cell along the scribing line.

18. The method according to claim 17, further comprising inspecting the liquid crystal cell.

19. The method according to claim 17, wherein one of the first and second substrates includes a plurality of gate lines and a plurality of data lines.

20. The method according to claim 19, further comprising inspecting the liquid crystal cell wherein the gate and data lines are supplied with voltages via shorting bars.

21. The method according to claim 20, further comprising grinding edge portions of the liquid crystal cell to remove the shorting bars.
